(19) United States
(12) Patent Application Publication
(10) Pub. No.: US 2022/0410328 A1
(43) Pub. Date: Dec. 29, 2022

(54) DRIVEN TOOL HOLDER HAVING MULTIPLE TURBINES

(71) Applicant: WTO Vermögensverwaltung GmbH, Ohlsbach (DE)

(72) Inventors: Karlheinz Jansen, Schutterwald (DE); Klaus Maier, Ortenberg (DE); Baruch Books, KFAR VRADIM (IL); Aviatar Schweitzer, ATLIT (IL); Yitzhak Oz, TAL-EL (IL)

(73) Assignee: WTO Vermögensverwaltung GmbH, Ohlsbach (DE)

(21) Appl. No.: 17/641,834

(22) PCT Filed: Sep. 11, 2020
(86) PCT No.: PCT/EP2020/075558

§ 371 Date: Mar. 10, 2022

(30) Foreign Application Priority Data
Sep. 13, 2019 (DE) 10 2019 124 761.6

(51) Int. Cl. B23Q 5/06; B23Q 5/04

(52) U.S. Cl. CPC B23Q 5/06; B23Q 5/043

(57) ABSTRACT

A tool holder which is provided with a plurality of different free jet turbines so that it can be operated, depending on the machining task, with different working rotational speeds and in different operating points.

The invention concerns a driven tool holder, the spindle of which is put into motion by a free jet turbine. The free jet turbine can be driven by a liquid or gaseous fluid (for example, a cooling lubricant or air) or a two-phase mixture.

### STATE OF TECHNOLOGY

DE 10 2009 012 805 A1, EP 3 043 957 B1, EP 2 623 258 B1 and DE 10 2016 212 896 B4 describe the use of a free jet turbine to drive the spindle of a tool holder.

DE 100 41 854 A1 describes a spindle head, the spindle of which is driven with compressed air. A proportional valve is installed to regulate the rotational speed of the spindle. A portion of the excess pressure is broken down in the proportional valve in order to reduce the rotational speed of the spindle as needed.

A proportional valve is a (static) valve that not only allows a few discrete switch positions, but also allows a constant transfer of the valve opening or switch position. Flow valves influence the volume flow [cm³/s] of a fluid. Proportional valves with an input and an output are also referred to as flow valves. There are also proportional valves with more than two work ports.

JP 2006 102 835 A describes a spindle unit comprising two rotors. The rotors are connected to a shared compressed air supply. A similar design is described in U.S. Pat. No. 3,055,12, which describes a dentistry drill also driven by compressed air.

U.S. Pat. No. 3,305,214 describes a differential turbine that is also driven by compressed air, and which comprises two turbine wheels rotating in reverse directions on a shaft. The torque transferred by the turbine wheels to the turbine shaft via a frictionally engaged mechanical linkage depends on the difference between the rotational speeds of both turbine wheels.

The spindle of the tool drive has a tool intake for a tool. Low tool diameters require very high rotational speeds in order to facilitate economical and high-quality processing.

Free jet turbines comprise a rotating rotor and one or more fixed nozzles. The fluid exits the nozzle(s) at a high speed. The fluid makes contact with the rotor, causing the rotor and the spindle to rotate.

The pressure energy of the fluid is converted into kinetic energy in the nozzle(s). The pressure difference of the fluid before and after the nozzle determines the maximum achievable speed of the fluid jet. The product of the speed of the fluid and the cross section of the fluid jet emitted by the nozzle determines the available output of the fluid. The rotational speed and torque of the turbine depend on the diameter of the rotor.

The free jet turbines used in power generation (generally Pelton turbines) work with a constant rotational speed specified by the net frequency. The speed of the water emitted by the nozzles is also constant due to the constant pressure head, and the flow rate is defined by the water supply.

The requirements of small-scale turbines for driving a tool differ considerably from this. Various materials (e.g., steel or aluminium) or diameters of the tools used (e.g., milling cutters or drills with 1 mm or 3 mm diameters) require an adjustment of the rotational speed and the available torque to facilitate effective processing.

With the solutions available, the output and rotational speed of the turbine can solely be adjusted via the pressure difference in the nozzle, and thus the jet speed of the fluid, due to the unalterable nozzle cross sections.

If such fluid-driven tool holders are supplied with cooling lubricant as a work fluid, the cooling lubricant pump present on the tool machine is “misappropriated”. These pumps intended for a different purpose (conveying cooling lubricant to the tool sheaths) often do not allow arbitrary adjustment of the conveying pressure and volume flow. Depending on the characteristic curve of the machine's pump, the pressure can drop and further limit the setting range in the event of larger volume flows.

In order to counteract this, the manufacturers of such tool holders offer a wide range of different tool holders, the turbine of which has been optimised for certain rotational speed ranges and torque ranges depending on turbine diameter, turbine design, and nozzle arrangement. If the relatively narrow work range of a driven tool holder is not suitable for the processing of a specific work piece, the user must obtain an additional tool holder, the turbine of which has a suitable work range for the respective task. The investment costs increase more or less in line with the number of tool holders. Furthermore, optimisation or alteration of the work range of the tool holder during processing is not possible, as the entire tool holder must always be replaced with the tool in order to change the rotational speed or torque of the spindle.

### Task

The invention aims to provide a tool holder that overcomes the drawbacks of the current state of technology. In particular, a tool holder that can be flexibly adapted to various materials and tools, and with a wide work range, is provided.

This is achieved with a driven tool holder comprising a spindle with a tool intake and a free jet turbine, whereby the free jet turbine comprises a rotor on the spindle, as the free jet turbine comprises two or more nozzle arrangements and at least one directional valve, each nozzle arrangement is assigned a fluid supply line, and the lines are opened and/or closed with the directional valves.

A nozzle arrangement as described by the invention comprises one or more nozzles. By operating the directional valve(s) of the invention, the nozzle arrangements of a tool holder can be individually or jointly supplied with the pressurised work fluid. This increases the work range of the free jet turbine significantly. For example, the torque of the free jet turbine of the invention can be doubled by activating a second nozzle arrangement of identical design if both nozzle arrangements are concordantly facing the rotor. A different design of the nozzle arrangement, e.g., by changing the number of nozzles and/or altering the output surfaces of the nozzles, can be used to control the output of the free jet turbine in another range under equivalent hydraulic marginal conditions.

Contrary to the state of technology, the invention works with directional valves, which are used to control the supply of one or more nozzle arrangements with pressurised fluid. For reasons of linguistic simplicity, sometimes only a “valve” is referred to when discussing the invention; this always refers to a “directional valve”. Following this, the volume flow of the fluid impacting one or more rotors can be regulated or altered. The rotational speed and torque of the spindle of the tool holder are regulated in an energy-efficient way with minimal loss. The regulation of rotational speed and torque described by the invention is sufficiently precise and requires only little installation space.

If, for example, the hydraulic output provided by a second line is twice that provided by an initial line, the output can be altered significantly in three stages by switching between the first and second line, or simultaneous supply of both lines in a very wide range with equal pressure on the fluid:
Full output with simultaneous supply of both turbines.
⅔ of full output by supplying only the second turbine.
⅓ of full output by supplying only the first turbine.

The torque that can be applied to the spindle or tool intake is controlled by the activation or deactivation (closing or opening) of lines. The lines or the nozzle arrangements attached to them can be directed toward a rotor or various rotors of the spindle.

Changes in fluid pressure can widen the work range even further.

This means that one and the same tool holder can be used for a wide range of processing types. The required torque can be easily controlled by activating a directional valve.

When the invention is designed optimally, the fluid from the at least two lines or nozzle arrangements drives the spindle in opposing directions of rotation. The directional valve needs only be activated once in order to reverse the direction of rotation. The reversal of the direction of rotation can be realised with only one rotor, if the tool holders described by the invention are being used. This is particularly affordable and requires almost no additional installation room, and the tool holder is thus quite compact. However, it is also possible to install one or more rotors for each direction of rotation and rotational speed.

The work range of the tool holder described by the invention can be further widened if the free jet turbine comprises two or more rotors on the spindle, and each rotor is assigned at least one line. Various rotor diameters allow the rotational speed and torque of the free jet turbine to be optimally adjusted for the material being processed, the processing (scrubbing/smoothing), and diameter of the material.

In many cases it is advantageous if two or more rotors with their respective lines are integrated in a tool holder. This means that multiple free jet turbines are available, each of which is optimised for one work range. One way in which this optimisation can be performed is for the main measurements of the turbine (incl. rotor diameter and width of the scoops of the rotor) and the design of the rotor, as well as the number and layout or dimensions of the nozzles to be optimally coordinated with each other. The turbines can be operated individually or together. Only one directional valve need be activated to do this.

In order for the tool holder described by this invention to be as compact as possible in the tool intake, at least one of the rotors can be located at a second end of the spindle. The second end is opposite the first end of the spindle with the tool intake. According to the invention, there is at least one rotor on the first and second end of the spindle. This allows greater freedom in the design of the tool holder.

The spindle of the tool holder is positioned in a tool holder casing in such a manner that it can be rotated, and the rotors are preferably located on the ends of the spindle protruding beyond the bearing. This makes it easier to install and to seal the bearing against the turbines' work fluid.

Overall, the case with all tool holders described by the invention is that the directional or flow valves are manually, electrically, mechanically, hydraulically, or pneumatically activated. Certain switch positions of the directional valve(s) are repeatable and can be automated. The user can thus always apply a suitable setting (tool, material for processing, switch position of the directional valve(s), and conveyance output of the pump) as needed without having to put in the effort of defining and testing the setting.

Another advantage of the tool holder described by the invention is that it can be very flexibly used in a variety of tool machines. For example, if the tool holder is used on a tool machine, the pump of which only offers a small conveyance flow for the cooling lubricant, only one nozzle arrangement is activated. When using the tool holder on a tool machine with more efficient pump, two or more nozzle arrangements can be active.

The directional valve(s) can facilitate a wide range of combinations of activated nozzle arrangements and rotors, depending on design.

If the tool holder and the machine on which the tool holder is used are equipped with an automatic tool alternation system, various cutting tools can be alternated and then operated with the selected, matching turbine.

A nozzle arrangement can comprise one or more nozzles, which generally have the same design.

It is possible for the fluid conveyed by the pump to be distributed among two or more nozzle arrangements (parallel activation). This in itself facilitates the broad regulation of the rotational speed and the torque exerted on the spindle.

Another variation of the rotational speed and the torque exerted on the spindle is achieved by the invention in that there are two or more rotors with various diameters on the spindle. The rotational speed and spindle torque change depending on which of the rotors is supplied with fluid.

Both control methods facilitated by the invention (activation and deactivation of various nozzle arrangements and supplying various rotors with fluid) can be facilitated by a tool holder and work cumulatively. The rotational speed and torque of one and the same tool holder can thus be broadly regulated.

In an ideal variant of the design of the directional valve described by the invention, this comprises a circular positioning ring and an annular or conical sealing surface in the housing that interacts with the positioning ring. The lines that supply the nozzle arrangements with pressurised fluid are distributed along the circumference of the sealing surface via a central angle α. Depending on the rotational position of the positioning ring relative to the housing, the positioning ring closes or releases one or more of the lines. The more lines that are open, the more fluid flows through the lines to the rotor(s) in total. By turning the positioning ring relative to the housing, the number of nozzle arrangements supplied with the pressurised fluid changes, and with it the torque exerted on the spindle by the rotors supplied with the fluid and which is then supplied at the tool intake for the cutting process.

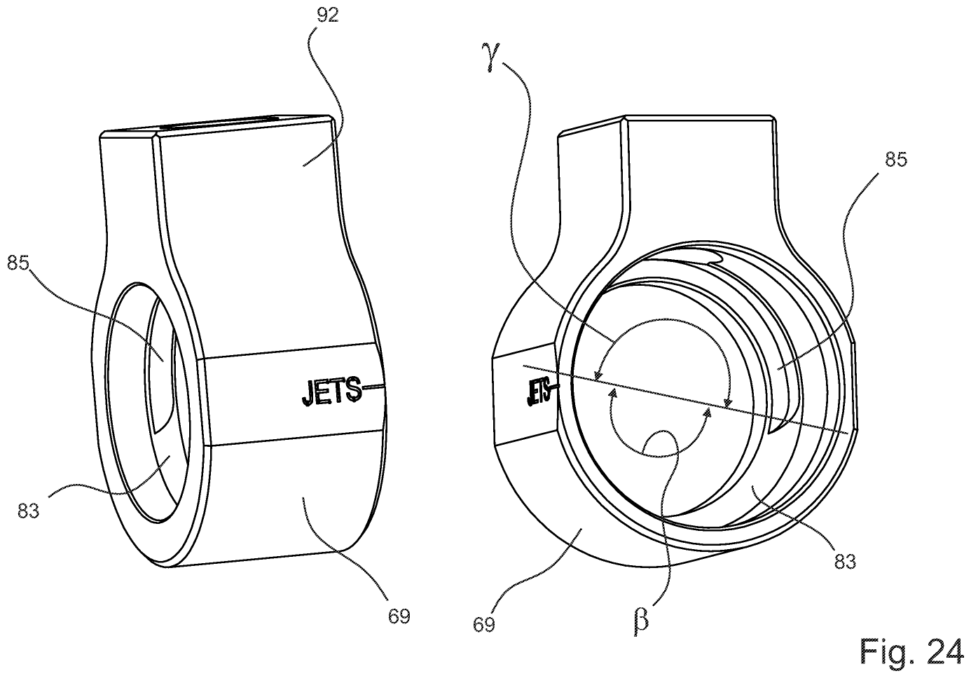

To this end, a particularly advantageous design of the positioning ring comprises a countersurface to complement the sealing surface of the housing, which is in turn designed as a circular ring or cone with a central angle γ (see FIG. 24). The central angle γ is less than 360°. It is generally less than 200° and higher than 135°. There is a recess at the remaining circumferential angle 13 M=360°−γ) of the positioning ring. This means that, depending on the rotational position of the positioning ring relative to the housing, the countersurface of the positioning ring either opens or closes one or more of the lines that run from the sealing surface in the housing. The housing and positioning ring border a fluid chamber where there is no countersurface, but rather the recess. This fluid chamber provides fluid to the lines not closed by the countersurface of the positioning ring. The fluid chamber itself is supplied with pressurised fluid via a supply hole, but preferably via multiple supply holes.

So that the fluid chamber that “moves” with the positioning ring can always be supplied with pressurised fluid regardless of the rotational position of the positioning ring relative to the housing, it is recommended that five or six supply holes be provided in the housing that, from a central line, at least partially divide or penetrate the sealing surface in the housing.

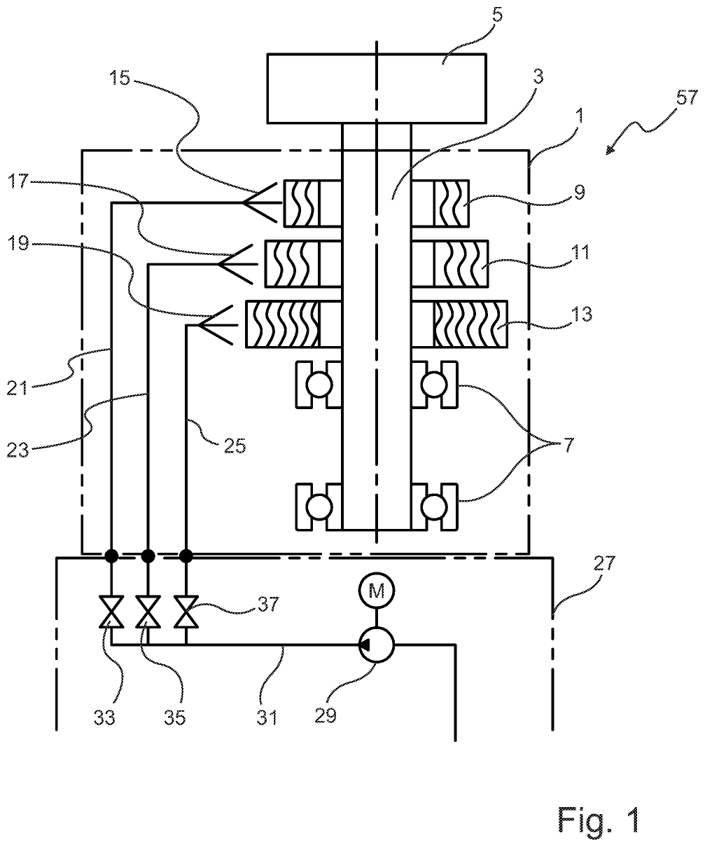

In the case of the tool holder described by the invention, there are two possible means for tool intake in the integration of the spindle. The first possibility is that the spindle comprises a tool intake in which the tool is braced. All tool intakes known from the current state of technology describe this. This concept is also illustrated in FIGS. 1 to 13.

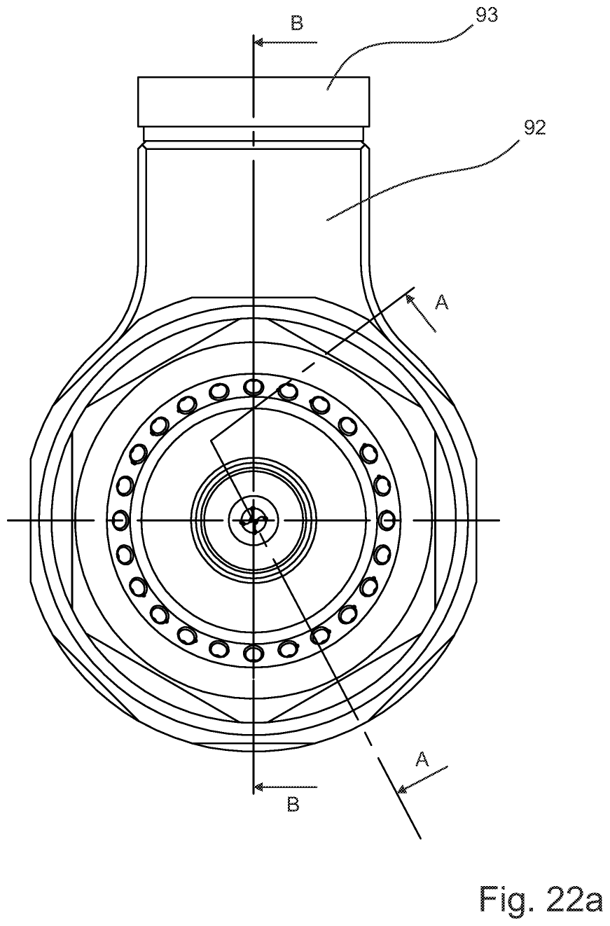

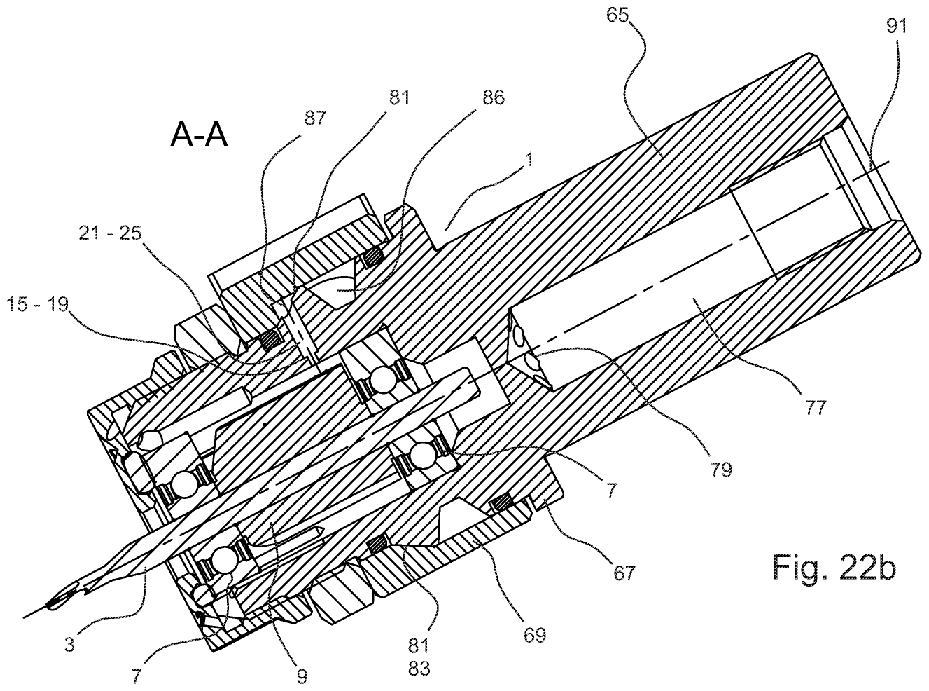

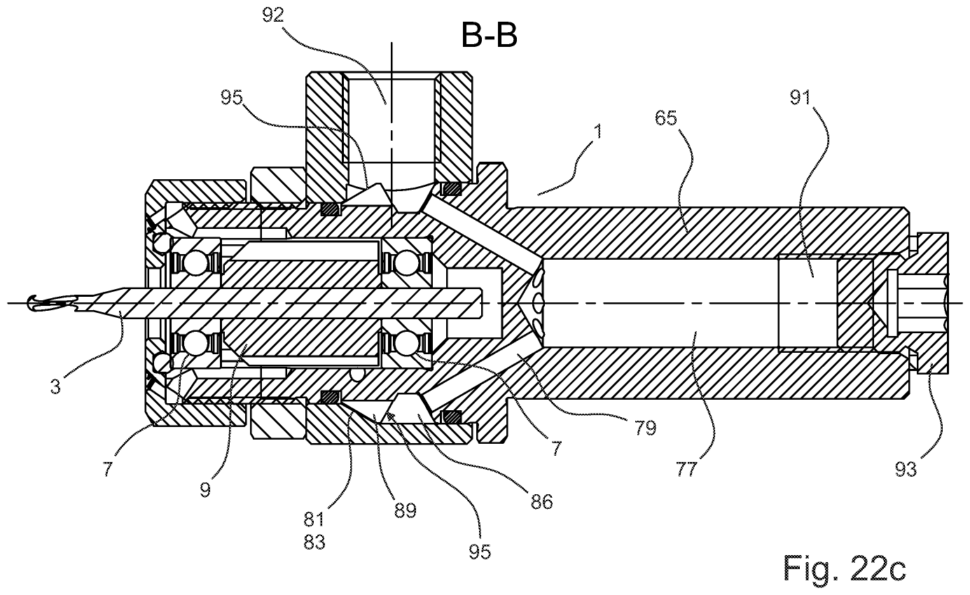

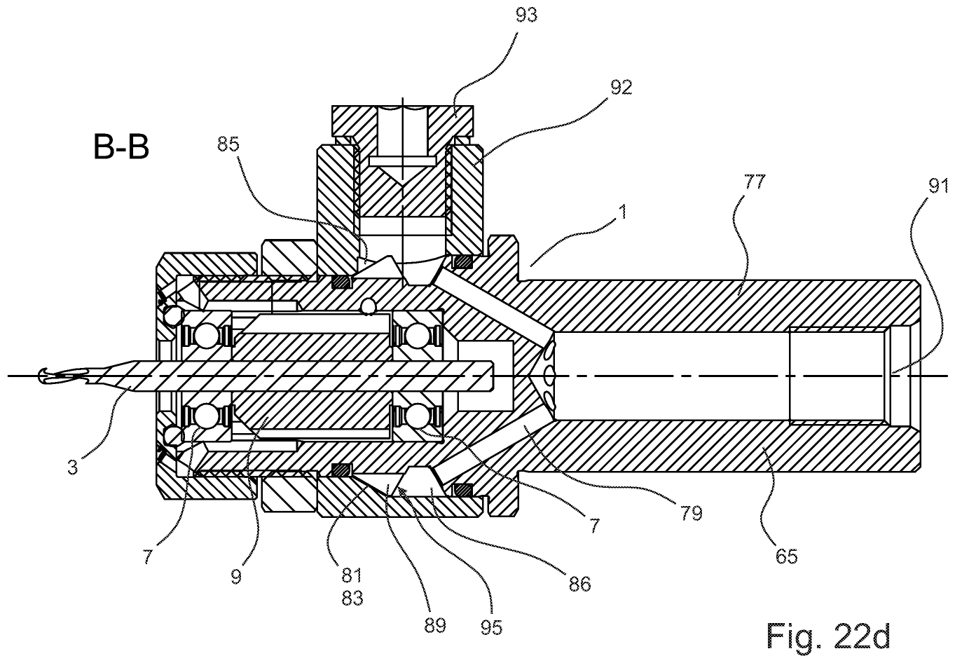

The second possibility is that the tool is integrated into the spindle. This integration allows further miniaturisation and results in less rotational inertia of the rotating components (rotors, spindle, tool). This concept is illustrated in FIGS. 22 b, c, and d, as well as 25 to 27.

Further advantages and advantageous designs of the invention can be found in the illustrations, description, and patent claims. All characteristics listed in the illustrations, description, and patent claims can be pertinent to the invention either individually or in any combination with one another.

### ILLUSTRATIONS

The illustrations show the following:

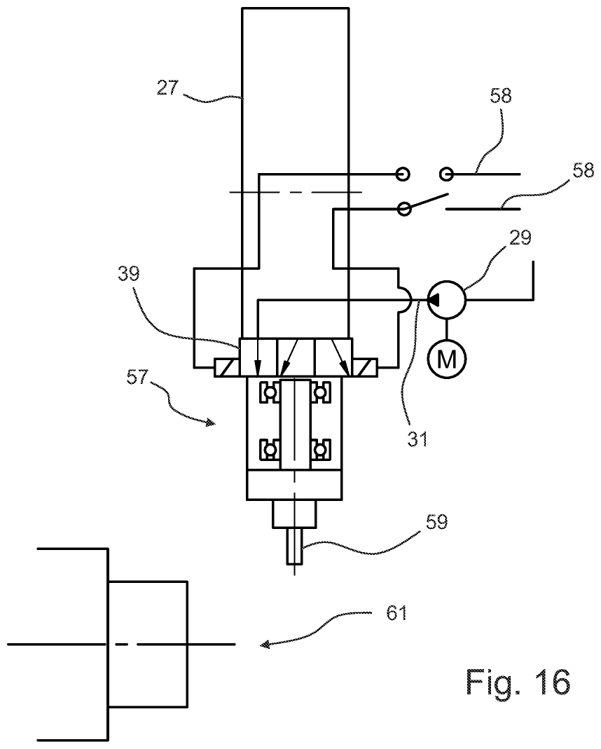

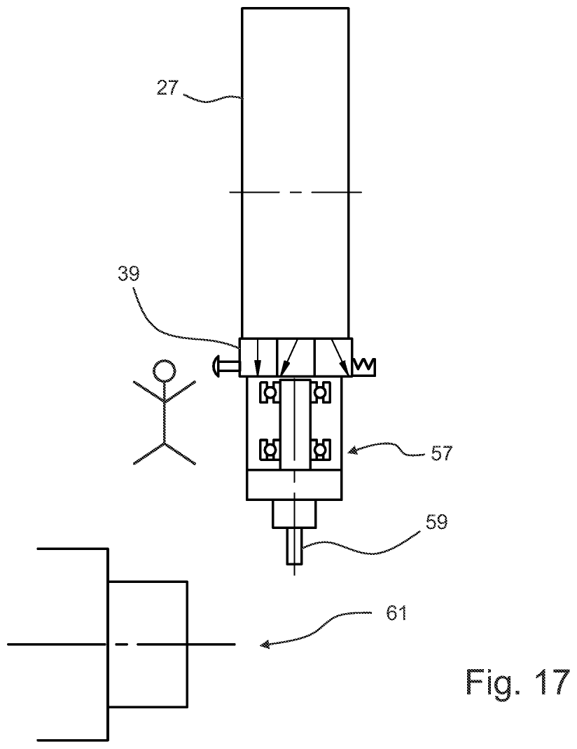

FIGS. 1 to 18 are schematic depictions of various designs of tool holders described by the invention;

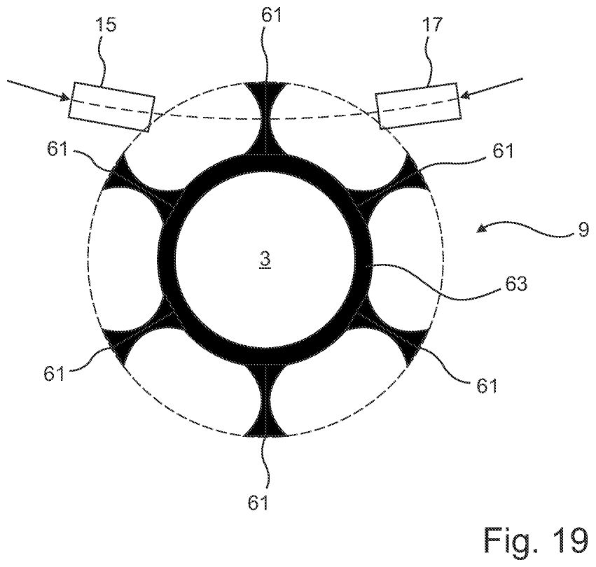

FIG. 19 is a rotor with two directions of rotation described by the invention;

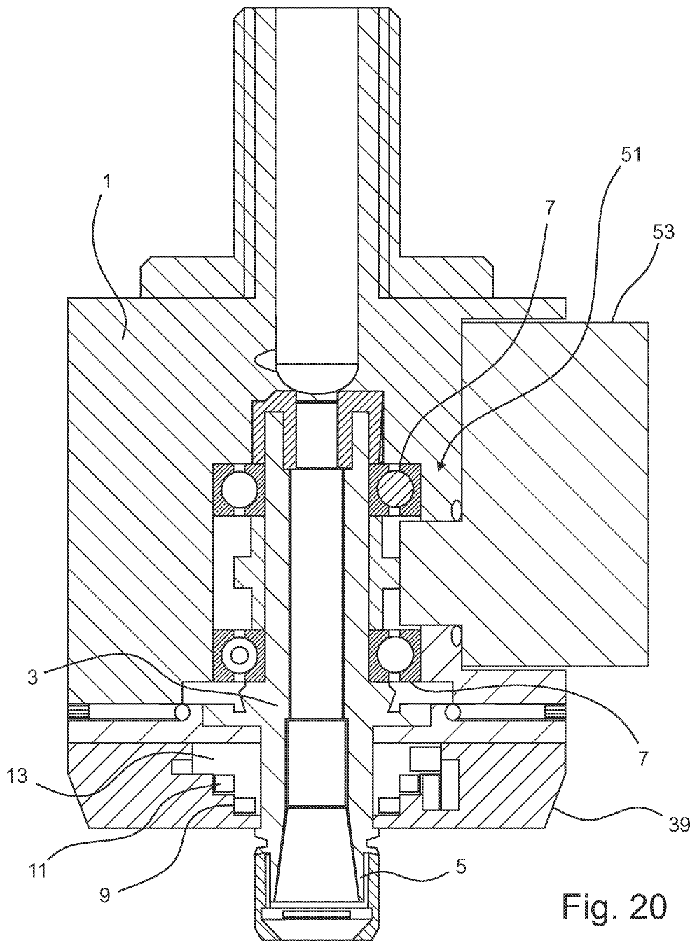

FIG. 20 is a cut through a tool holder described by the invention, while

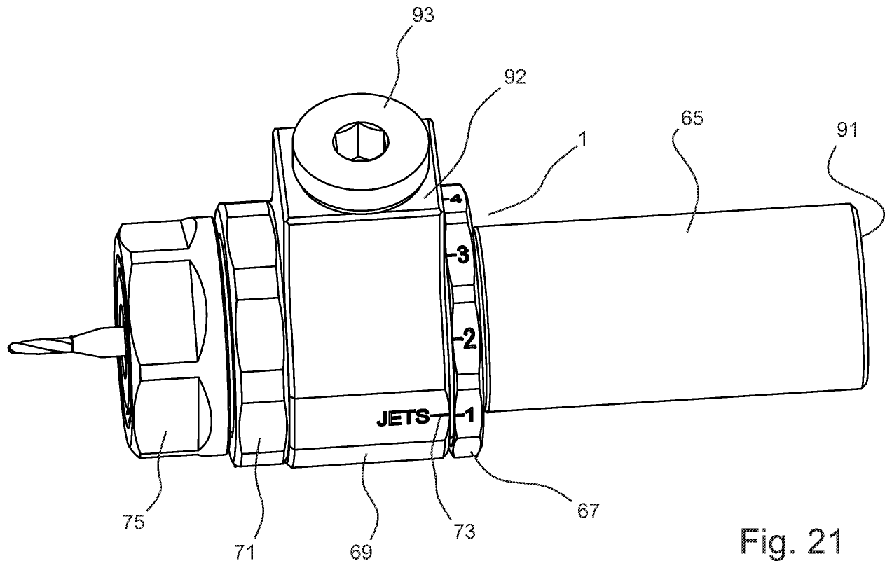

FIG. 21,

FIGS. 22, 22b, 22c, 22d, and

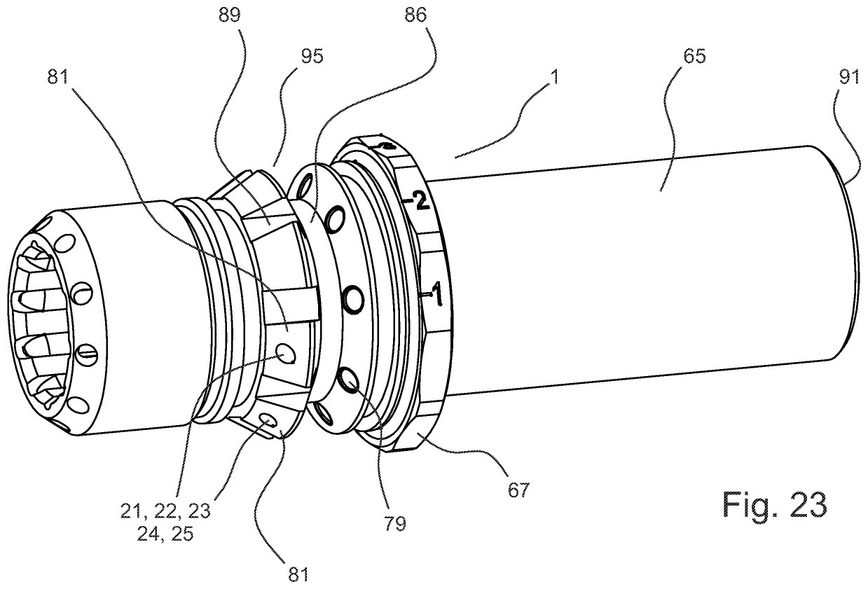

FIGS. 23 to 27 are depictions of other variants of the tool holder described by the invention.

### DESCRIPTION OF THE EXAMPLE VARIANTS

FIGS. 1 to 18 contain highly simplified, schematic depictions of various designs of tool holders described by the invention in order to illustrate the principle of the invention. The same references are used for the same components in all illustrations, and that which has been said of a specific example variant applies to the other example variants as well. The tool holder depicted is always presented as a “straight” tool holder in the figures. However, the spindle 3 for intake in the work machine can of course take any spatial position (angle, displacement, etc.).

The tool holder can be used for all types of tool machines (milling centres, rotating centres, multi-task centres, etc.), and be mounted onto the tool machine via all tool intakes known from the current state of technology (e.g., steep taper, HSK, Coromant Capto, cylinder shaft, etc.).

FIG. 1 depicts a driven tool holder 57 comprising a housing 1 and a rotating spindle 3 within the housing 1. A tool intake 5 is depicted schematically at an initial end of the spindle 3. A tool suitable for processing (e.g., a shank-type cutter or a drill) is braced in this tool intake 5. The tool intake 5 can be a collet intake or another bracing system known from the current state of technology.

The bearing of the spindle 3 in the housing 1 is indicated by two (roller) bearings 7.

In this example variant, there are a total of three rotors 9, 11, 13 on the spindle 3. The rotors 9, 11, 13 are firmly and (ir-)revocably connected to the spindle (e.g., via press fit, soldering, or welding), or form one component with the spindle 3. Each of these rotors 9, 11, 13 has a different diameter. The rotors 9, 11, 13 can also form one component and be attached to the spindle 3 as one unit. It is also possible to create the rotors 9, 11, 13 and spindle 3 from one piece.

In this example, each rotor 9, 11, 13 is assigned one nozzle arrangement 15, 17, 19. The nozzle arrangements 15, 17, 19 are each supplied with fluid via a respective line 21, 23, 25.

The driven tool holder 57 described by the invention and its housing 1 is fastened, for example, to a revolver 27 of a tool machine. The tool machine comprises a pump 29 with which cooling lubricant or another fluid can be conveyed. The pump 29 is generally driven by an electrical motor (M). The lines 21, 23, 25 are hydraulically connected with a conveying side 31 of the pump 29.

Between the conveying side 31 and lines 21, 23, 25 are, for example, directional valves 33, 35, 37 or a directional valve (not depicted) with multiple work ports. Each of the directional valves 33, 35, 37 depicted here can be actuated individually. If, for example, the directional valves 35, 37 are closed and only the one directional valve 33 is open, the nozzle arrangement 15 is supplied with fluid conveyed by the pump 29. The fluid emitted from the nozzle arrangement 25 drives the rotor 9.

If, for example, the directional valves 33, 37 are closed and only the directional valve 35 is open, the nozzle arrangement 17 is supplied with fluid conveyed by the pump 29. The fluid emitted from the nozzle arrangement 17 drives the rotor 11. Because at least the rotors 9, 11, 13 are designed differently, the spindle 3 exhibits a different operating rotational speed depending on which of the nozzle arrangements 15, 17, and/or 19 is supplied with fluid from the pump 29.

If the various nozzle arrangements are directed toward the same rotor, the torque on the spindle can be regulated via activation and deactivation of individual lines.

In the example variants depicted in FIGS. 1, 2, and 3, the directional valves 33, 35, and (if applicable) 37 are part of the tool machine and not the tool holder. This necessitates multiple fluid interfaces (often one fluid interface for each nozzle arrangement 15, 17, 19) between tool machine and tool holder. These are indicated in the figures by black dots. The activation or deactivation of the nozzle arrangements 15, 17, 19 is very simple in this example variant, as all control and switch elements (e.g., directional valves 33, 35, 37) are located on the machine. However, this design requires a fluid interface at the connection point between the tool machine and the tool holder 57 for each nozzle arrangement 15, 17, 19. In other words: The tool holder then has three fluid connections.

The directional valves 33, 35, 37 can be actuated independently from one another. Actuation of the directional valves 33, 35, 37 facilitates distribution of the fluid conveyed by the pump 29 among one or more rotors 9, 11, 13. The rotational speed and torque present on the spindle 3 can thus be broadly regulated and adapted to the requirements of various machining tasks.

For example, only the nozzle arrangement 15 is supplied with fluid from the pump 29 if the (directional) valves 35, 37 are closed and only the directional valve 33 is open. The nozzle arrangement 15 supplies the rotor 9 with the fluid. Of the three rotors 9, 11, 13, the rotor 9 has the smallest diameter. Thus the rotational speed of the spindle 3 is the highest when the directional valve 33 is open and the rotor 9 is supplied with fluid, pending the identical design of the nozzle arrangements 15, 17, 19.

If a higher torque is required for another machining task, the (directional) valve 37 can be opened and the directional valves 33, 35 closed, for example.

The rotor 13, with the greatest diameter, is supplied with the fluid from the nozzle arrangement 19. In this switch position, the operating rotational speed of the spindle 3 is the lowest, although the torque is the highest.

If only the directional valve 35 is open, the middle rotor 11 is supplied with fluid, resulting in a medium operating rotational speed and medium torque.

The conveyance output of the pump 29 can also be altered.

Any other combination of switch positions of the directional valves 33, 35, 37 is possible to configure the rotational speed and the torque on the spindle 3. Two or more rotors can be simultaneously supplied with fluid.

Of course, the rotational speed and the torque on the spindle 3 can also be regulated via the pressure on the conveying side 31 or the conveyance output of the pump 29.

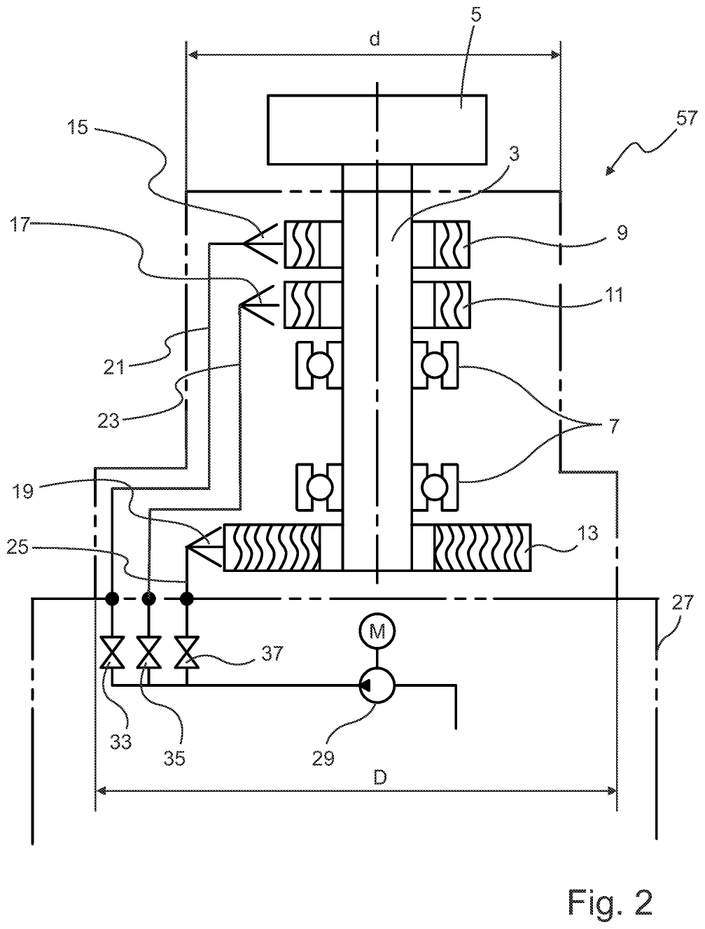

It goes without saying that this variant is merely an example. Other combinations are possible, some of which are described in FIGS. 2 to 13.

In the example variant of FIG. 2, the largest rotor 13 is located on a second end of the spindle 3. The second end of the spindle 3 is located opposite the tool intake 5. This means that the roller bearings 7 or the bearing of the spindle 3 are positioned between the rotors 11, 13. One of the bearings 7 thus moves closer to the tool intake 5 so that the spindle 3 becomes more stiff as a whole. This relieves the strain on the bearing of the spindle 3. The installation space requirements for the rotors 9, 11 are lower on the first end of the spindle 3 where the tool intake 5 is located. In this configuration, the tool holder is more narrow near the tool intake 5, as illustrated in FIG. 2, and indicated by the dimensions “d” and “D”. This facilitates the machining of work pieces even in areas that are difficult to reach.

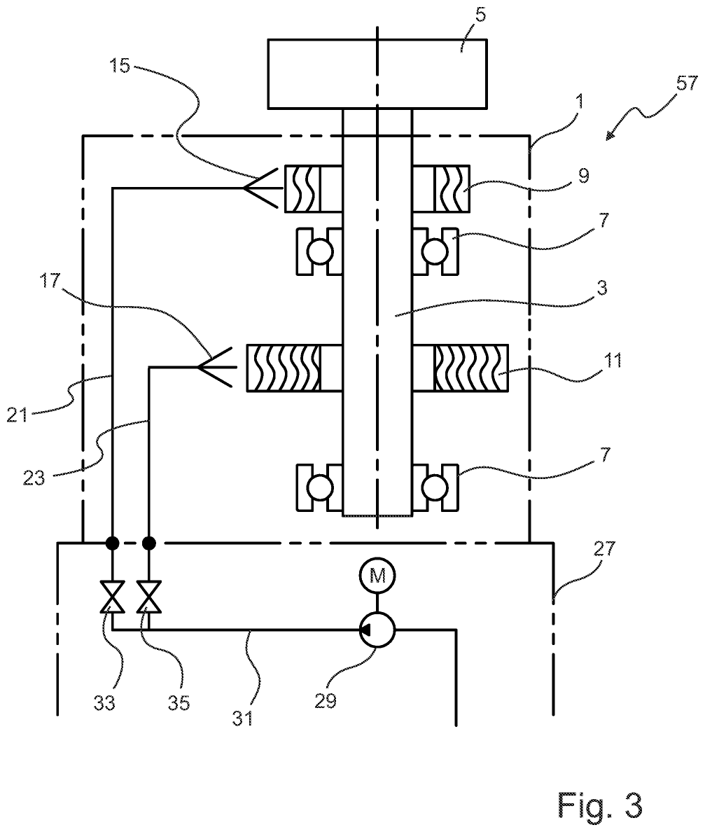

In the example variant of FIG. 3, there are two rotors 9, 11. The rotor 11 is positioned between the bearings 7. One of the bearings 7 is positioned at the second end of the spindle 3, so that the spindle 3 becomes more stiff as a whole. The dynamic strains resulting from the fluid jet from the nozzle arrangement 17 that hits the rotor 11, but also the forces stemming from the imbalance of a rotor, are transferred to the bearing with greater stability and fewer vibrations. Due to the often very high rotational speeds that are being worked with, the imbalance is a critical factor for a vibration-free processing of the tool and a good processing result. In this example variant, the tool holder has two fluid connections.

It is generally possible to position the rotors behind or between the bearings, and to select the positioning such that optimal installation geometry and optimal external geometry of the tool holder and/or bearing strain and vibration behaviour is achieved.

Furthermore, the installation room requirements for the rotor 9 are very low at the first end of the spindle 3 where the tool intake 5 is located.

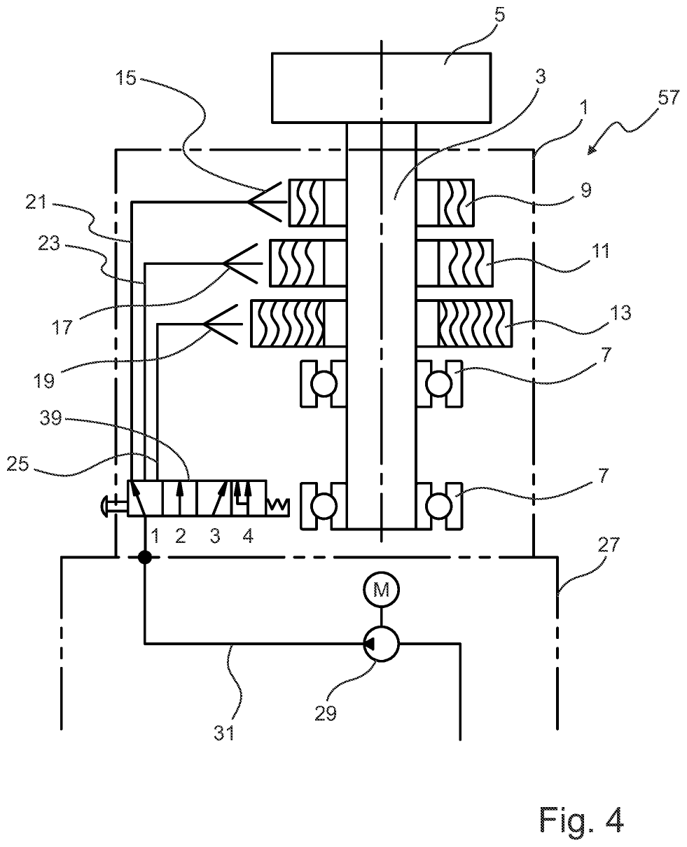

In the example variant of FIG. 4, the directional valves 33, 35, 37 are consolidated in one (directional) valve 39 with multiple connections and switch positions. The directional valve 39 in this example variant is integrated into the housing 1 of the tool holder 57. The fluid conveyed by the pump 29 is centrally guided via a hydraulic interface from the tool machine to the tool holder 57. The fluid then reaches the directional valve 39.

If the directional valve 39 is integrated into the tool holder 57, one fluid interface between the tool machine and tool holder 57 is sufficient. In this example variant, the tool holder has one fluid connection.

The directional valve 39 in this example variant has four switch positions 1, 2, 3, 4. Each of the switch positions 1 to 3 is supplied with work fluid by a respective nozzle arrangement 15, 17, 19.

In the fourth switch position, the nozzle arrangements 15 and 17 supply the rotors 9 and 11 with fluid simultaneously or parallel. This creates greater torque on the spindle 3 than if only one of the rotors 9, 11, 13 is supplied with fluid. In general, the directional valve 39 facilitates the supply of one or more nozzle arrangements 15, 17, 19 with fluid in a wide range of combinations, depending on the design and switch position.

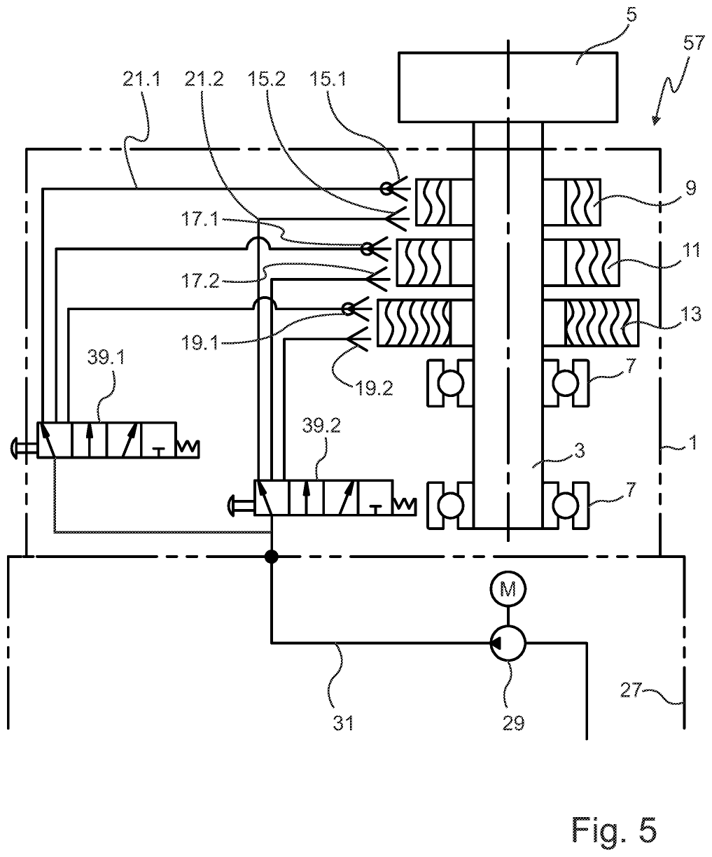

The parallel actuation of two nozzle arrangements 15 and 17 does not necessarily require two separate rotors 9 and 11. It is also possible to design a rotor more broadly so that two nozzle arrangements influence one rotor. One such configuration is shown in FIGS. 5 and 21. The rotors 9, 11, 13 are so broad that two nozzle arrangements influence one rotor.

Furthermore it is possible, with a consistent rotor breadth, to position multiple nozzle arrangements 15, 17, 19 in succession around the circumference of a rotor. The respective rotors can be configured for various nozzle arrangements and fluid conditions in this manner.

For example, the nozzle arrangement 15 can be configured such that a maximum output speed of the fluid is achieved. The nozzle arrangement 17 can be configured such that the output speed of the fluid is lower, but the output cross section of the nozzle arrangement 17 is greater. The nozzle arrangement 17 can thus be used to accelerate the spindle 3 for scrubbing work, while the nozzle arrangement 15 is used for smoothing. Both nozzle arrangements 15, 17 can be directed toward the same rotor 9.

With the example variant schematically depicted in FIG. 5, the nozzle arrangements 15, 17, 19 and the lines 21, 23, 25 and the directional valves 39.1 or 39.2 are each duplicated. For reasons of comprehensibility, not all lines have been assigned a reference number.

It is thus possible, for example, to supply the smallest rotor 9 with fluid from the nozzle arrangement 15.1 and/or the nozzle arrangement 15.2. Accordingly, the rotors 11, 13 can also optionally be supplied with fluid from the nozzle arrangement 17.1 and/or 17.2 or 19.1 and/or 19.2.

The number of switch combinations is thus more than doubled, and the application range of the tool holder 57 is expanded significantly. The hydraulic connection to the tool machine or pump 29 can be performed via an interface, as pictured, or via multiple connections.

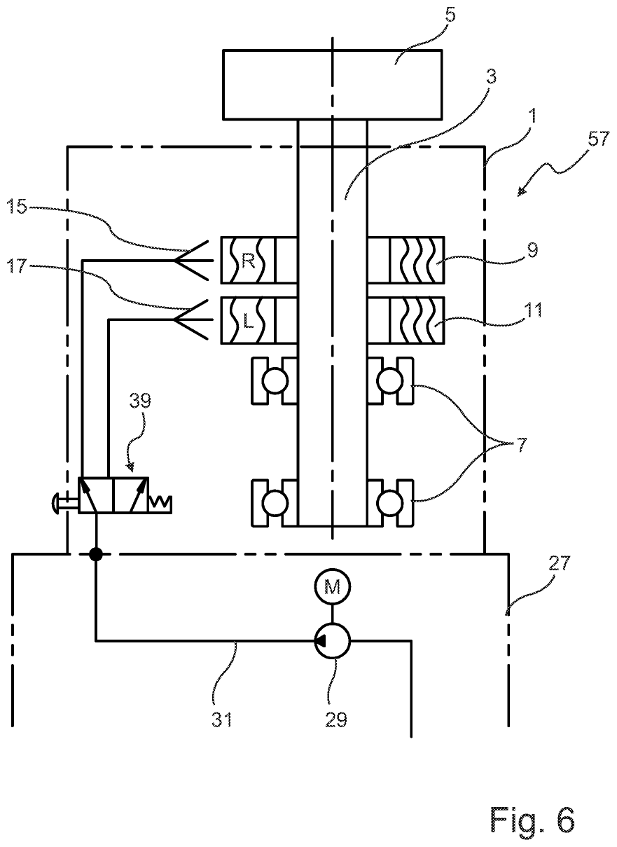

FIG. 6 depicts an example variant in which two rotors 9, 11 are positioned on the spindle 3. The rotational directions of the rotors 9, 11, and thus the alignment of the nozzle arrangements, are different. This is indicated by “R” on the rotor 9 in FIG. 5 and “L” on the rotor 11 in FIG. 6. The rotational direction of the rotor 9 is clockwise (right-rotating), and the rotor 11 rotates counter-clockwise (left-rotating).

The diameters of both rotors are the same in this example variant. But this is not required.

If the rotor 9 is supplied with fluid via the nozzle arrangement 15, the spindle 3 rotates clockwise. If the rotor 11 is supplied with fluid via the nozzle arrangement 17, the spindle 3 rotates counter-clockwise. The rotational speed and torque are equal in both rotational directions if the hydraulic configuration of the rotors 9 and 11 is the same.

The reversal of the rotational direction described by the invention facilitates new means of use and functionalities, such as thread cutting and the active braking of the spindle 3. The reversal of the rotational direction is also advantageous for complex machining with two-level tools (one level cutting to the left, the second cutting to the right). This option can be used for reverse machining. It also facilitates simple manual repositioning for a left-/right-cutting tool when setting up the machine.

It is also possible to realise this reversal of rotational direction with one rotor; see FIG. 19 and its description.

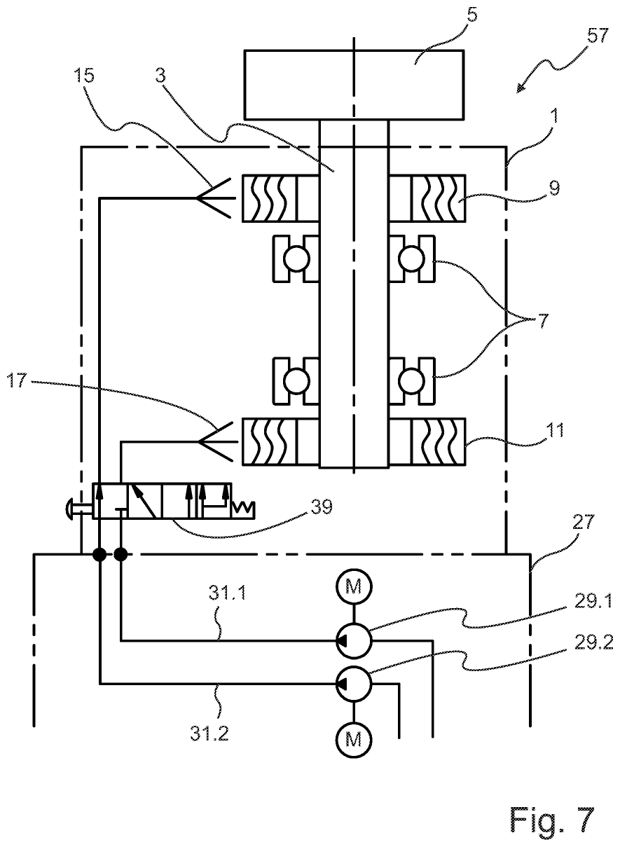

The example variant in FIG. 7 shows two pumps 29.1, 29.2. Both pumps 29.1, 29.2 can provide a liquid work fluid with various pressures and/or volume flows. Alternatively, one pump (e.g., 29.1) can convey a liquid fluid, while the second pump 29.2 conveys a gaseous fluid (air). In this case, the pump 29.2 would be, for example, a compressor or a connection to a fluid network (compressed air network). This further expands the work range of the tool holder 57.

Each fluid has a transfer point between the tool machine or the revolver 27 and the driven tool holder 57.

In the switch position of the directional valve 39 shown in FIG. 7, the nozzle arrangement 15 is supplied with fluid, whereupon the first rotor 9 is supplied with the fluid conveyed by the second pump 29.2.

In the second switch position of the directional valve 39 (not pictured), the nozzle arrangement 15 is supplied with fluid from the first pump 29.1. In a third switch position, the nozzle arrangement 17 that supplies the rotor 11 with fluid is supplied with fluid conveyed by the first pump 29.1. In the fourth switch position of the directional valve 39, both nozzle arrangements 15 and 17 are supplied with fluid either from the first pump 29.1 or the second pump 29.2, depending on the design of the directional valve.

The rotational speeds are limited by fluids such as water or cooling lubricant, but the torque is greater. By switching to compressed air as a work fluid, the rotational speed of the spindle 3 can be greatly increased. This means that the scrubbing process, which requires greater torque, can be performed with water as a work fluid. In the subsequent smoothing process, the spindle 3 is driven with compressed air. Very good surface quality can be achieved due to the considerably higher rotational speed.

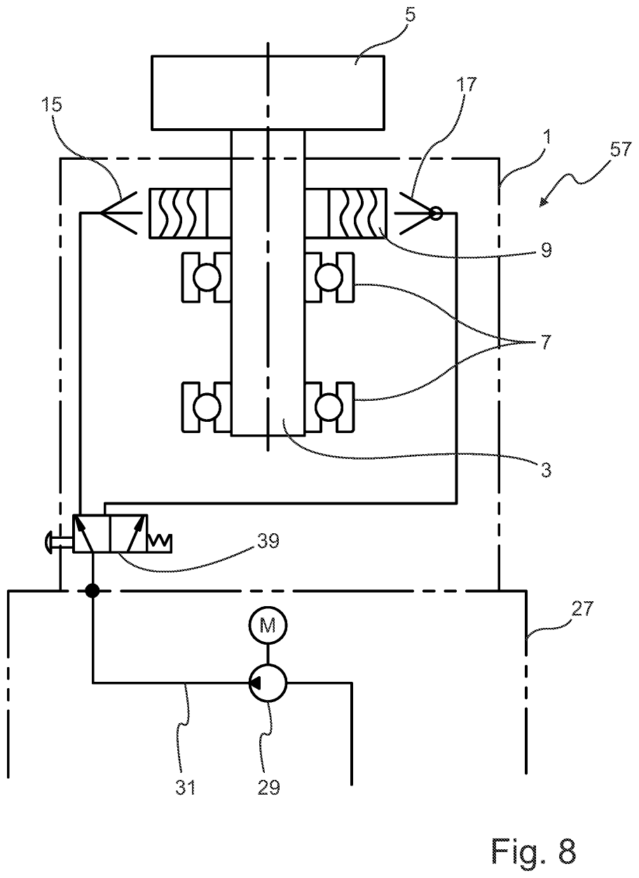

FIG. 8 shows an example variant of a tool holder with one rotor 9 and two nozzle arrangements 15, 17 that can be actuated separately. Both nozzle arrangements 15, 17 supply the same rotor 9 with fluid. The nozzle arrangements 15, 17 can, for example, vary with regard to the number of nozzles and/or the output surface of the nozzles. This can be used to regulate the hydraulic output of the fluid that makes contact with the rotor 9. As a result, the working rotational speed and/or torque of the spindle 3 also change.

In this example variant, the directional valve 39 has two switch positions. This example clearly illustrates how simple it is to switch between various nozzle arrangements.

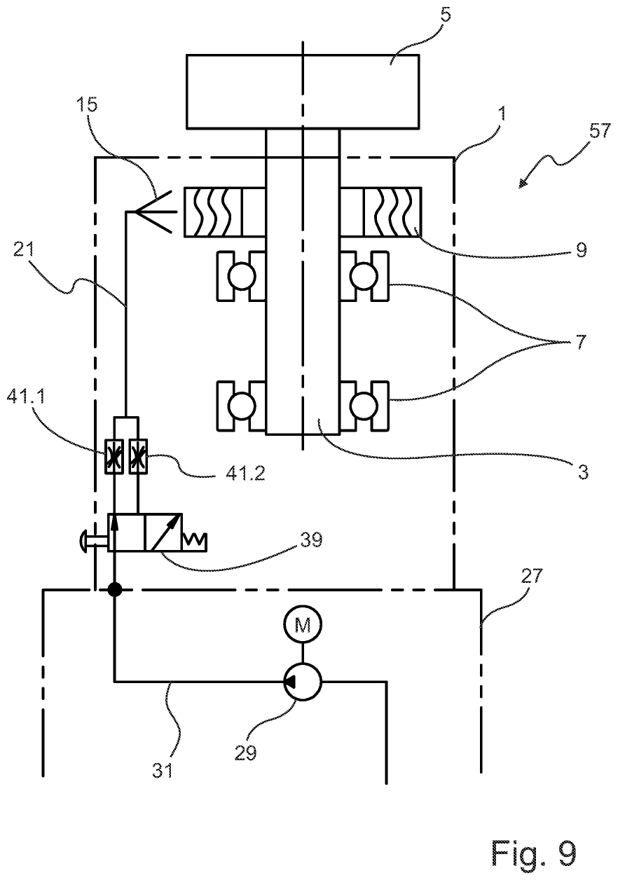

FIG. 9 shows an example variant in which two throttles 41.1, 41.2 or apertures with various characteristics are integrated in the line 21 downstream from the directional valve 39. The throttles 41.1, 41.2 respectively reduce the pressure or volume flow of the fluid conveyed by the pump 29 and which influences the nozzles. This allows for further adjustment of the work range of the tool holder 57. It is also possible to only provide one throttle 41 at the output of the directional valve 39 and to lead the other output into the line 21 without a throttle (not pictured).

In all example variants, it is necessary that the fluid conveyed by the nozzle arrangements 15, 17, or 19 onto one of the rotors 9, 11, and/or 13 is subsequently guided out of the housing 1 of the tool holder. This expulsion or diversion of the “used” fluid is not pictured in the FIGS. 1 through 9 for reasons of comprehensibility.

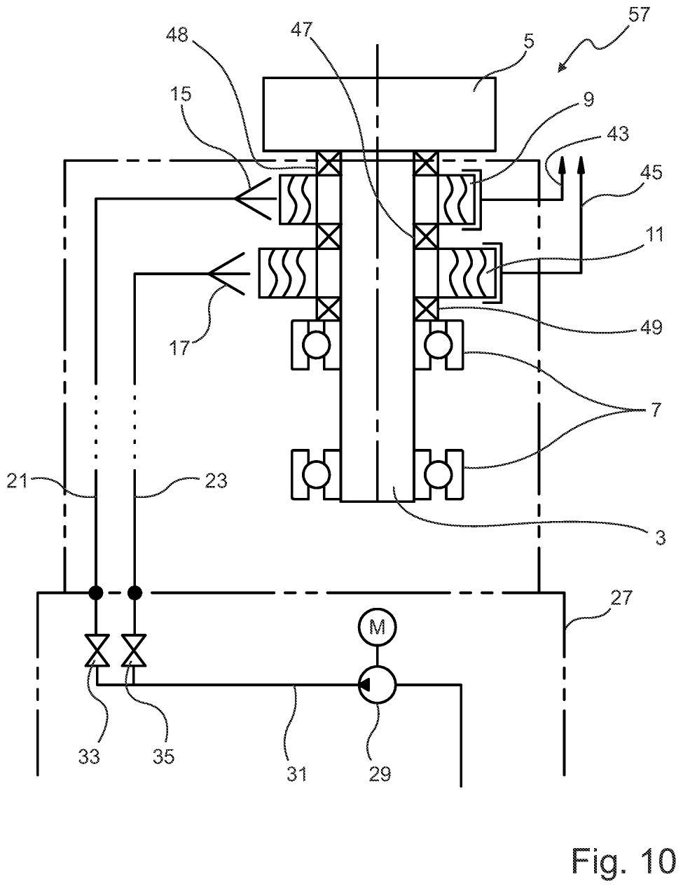

FIG. 10 provides a schematic depiction of diverters 43, 45 for the rotors 9, 11. In this example variant, the diverters 43, 45 are separated by a seal 47, meaning that the rotors 9, 11 do not mutually influence one another. This often improves the effectiveness of the turbines as the vortex reductions that would otherwise occur are avoided.

A seal 48 is indicated between the tool intake 5 and the rotor 9.

The (roller) bearings 7 are generally separated from the rotors 9, 11, or 13 by one or more seals 49. The seals can be contacting, non-contacting, or a combination of both.

The directional valves 33, 35 are part of the tool machine; it is also possible to control the nozzle arrangements 15, 17 via a directional valve integrated into the tool holder 57 (not pictured).

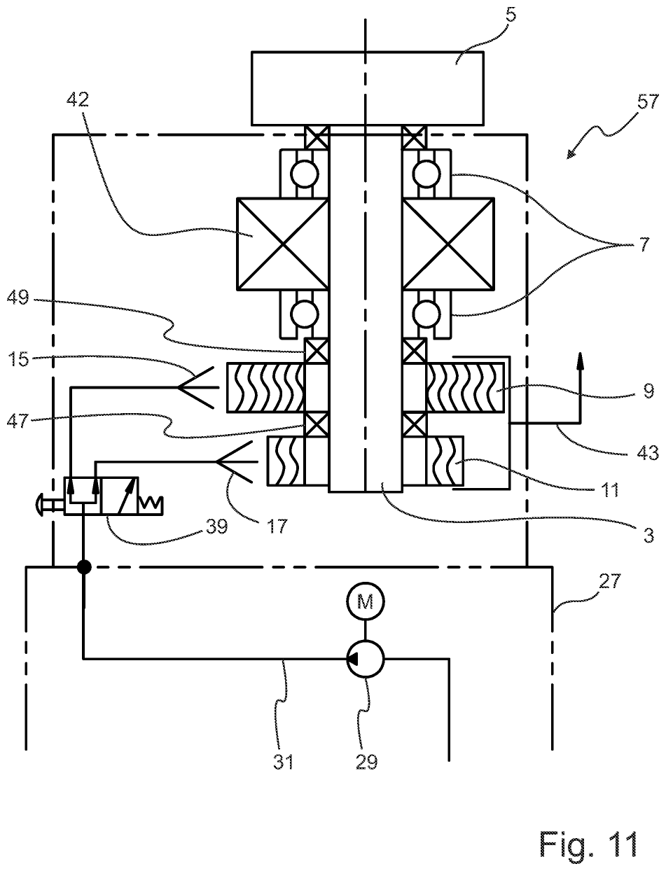

FIG. 11 shows an example variant with a flywheel mass 42 mounted onto the spindle 3. The flywheel mass 42 increases the rotational inertia of the spindle 3 and improves the smooth operation thereof. Due to the lower mass of the spindle 3, problems with vibration may occur in practice. A rotating flywheel mass 42 can be used to amend these issues in many cases.

However, due to the great rotational inertia of the flywheel mass, it is difficult for the spindle 3 to achieve the operating rotational speed with a small, accelerating turbine.

As shown in FIG. 11, both rotors 9, 11 can be supplied with fluid from the nozzle arrangements 15, 17 simultaneously or in parallel. This means that, during start-up, the flywheel mass 42 can first be accelerated by both rotors 9, 11 before only one of the rotors 9 or 11 subsequently induces the acceleration to the operating rotational speed and subsequent machining. In the example variant pictured, the nozzle arrangement 17 that supplies the rotor 11 with fluid is opened in the second switch position of the directional valve 39. Of course, the rotors 9, 11 can also be used individually to drive the spindle 3.

In this example variant, there is a joint diverter 43 for the rotors 9, 11.

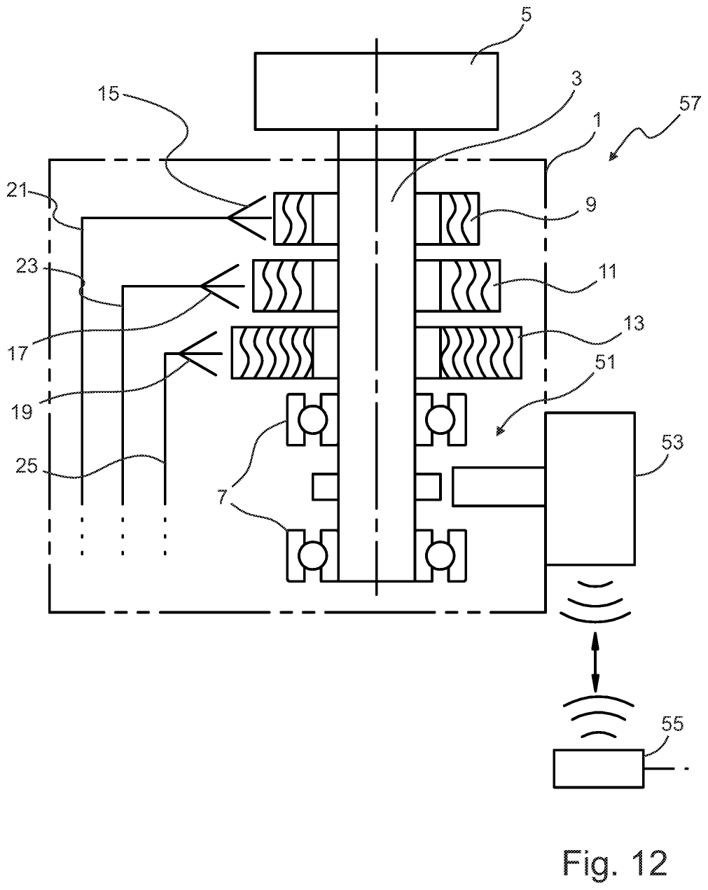

FIG. 12 contains a schematic depiction of a tool holder 57 equipped with sensors. The sensors 51 pictured can be used to detect a range of operating modes. For example, it may comprise a rotational speed sensor with a Hall sensor. The output signal of the rotational speed sensor is transmitted to an evaluation unit 53. From here, the output signal of the rotational speed sensor or other output sizes of the evaluation unit 53 can be wirelessly transmitted to a receiver 55, which in turn communicates with the controls of the tool machine.

Evaluation of the rotational speed of the spindle allows, for example, automated and optimised alternation between the various nozzle arrangements 15, 17, 19. The functionality of the control unit can also be integrated into the evaluation unit 53. The control unit connected to the sensors 51 also facilitates the actuation and operation of the directional valve(s) 35 to 39.

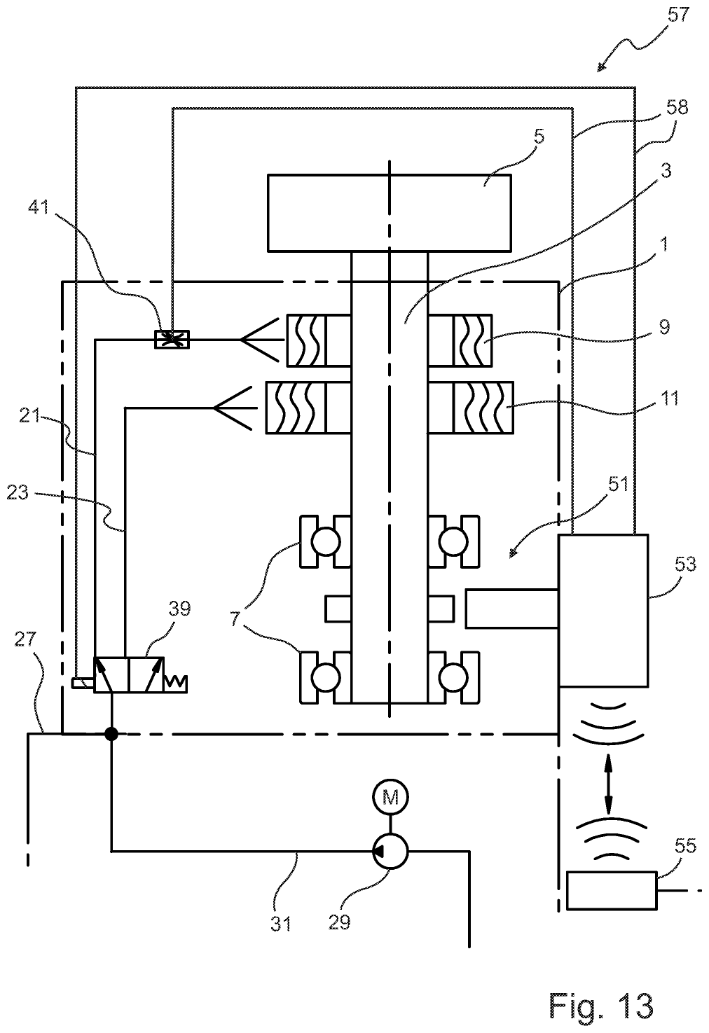

FIG. 13 depicts a very simplified configuration in which the control unit is integrated into the evaluation unit 53. The sensors 51 work with the evaluation unit 53, the sender of which transmits the data to a receiver 55. This transmission of data can also be bi-directional.

The evaluation unit 53 has direct connections 58 (wireless or via grid connection) with the directional valve 39 and the adjustable flow control valve or the throttle 41, so that the directional valve(s) 33 to 39 and/or the throttle 41 can be actuated depending on the rotational speed or other parameters recorded by the sensor 51. The output data from the sensor 51 can be evaluated, and the control signals transmitted via the connections 58 (e.g., signal lines) can be calculated either in the tool machine 58 or in the evaluation unit 53.

If the evaluation is conducted in the evaluation unit 53, data transmitted by the receiver 55 to the evaluation unit 53 can be included in the calculation. If the evaluation is conducted solely on the tool machine's end, the control signals are transmitted from the receiver 55 to the evaluation unit 53, and from there transmitted to the valves via the connections 58.

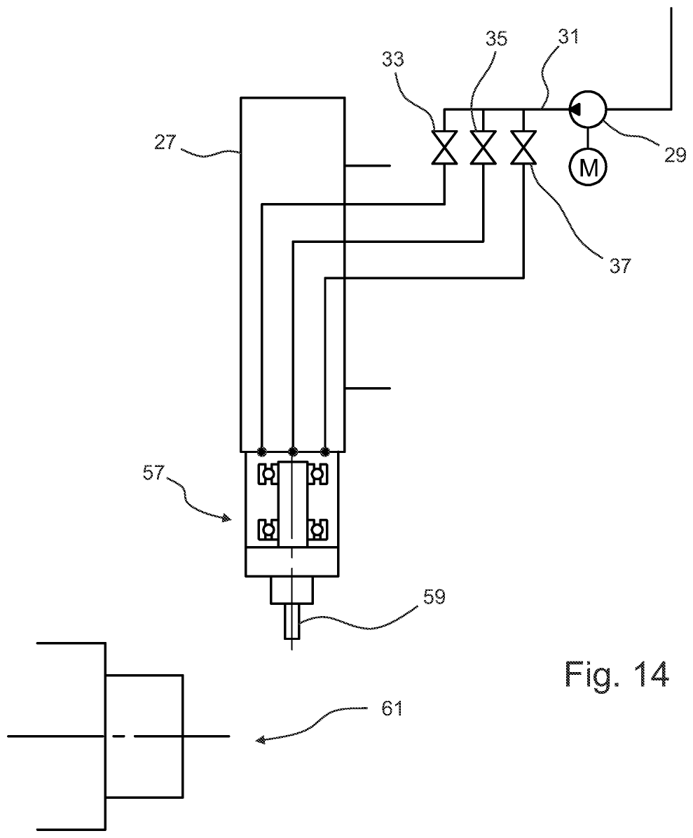

FIG. 14 once again depicts a full overview of a tool machine, using a centre of rotation as an example. The work piece 61 is braced in a machine spindle. The tool holder 57 is mounted on a tool revolver 27. The tool 59 is positioned in the tool intake 5 of the spindle 3 of the tool holder 57 described by the invention. The tool machine comprises a fluid intake that comprises a pump 29 with a motor (M) and one or more directional valves 33, 35, 37; the directional valves 33, 35, 37 are connected with the conveying side 31 of the pump 29. The directional valves 33, 35, 37 are in turn connected with the tool revolver 27 via lines and other elements not pictured such as rotary joints and other valves, and through the revolver 27 they are connected with the driven tool holder 57.

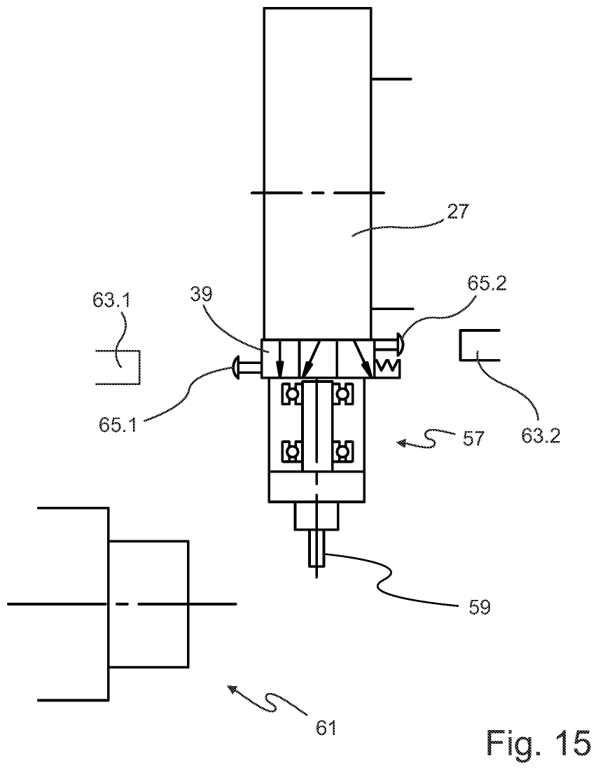

Various types of actuation of the directional valve 39 based on this configuration are presented below with FIGS. 15 to 18.

FIG. 15 schematically depicts a mechanical actuation of the directional valve 39 via the tool holder 57. Fixed stops 63.1, 63.2 are positioned on both sides of the revolver 27. Actuation bolts 65.1, 65.2 are positioned on both sides of the directional valve 39, which influence the actuator of the directional valve 39.

If the actuation bolt 65.1 of the directional valve 39 is moved against the stop 63.1, the actuator of the directional valve 39 is activated and the directional valve 39 adopts a different switch position. The other switch positions of the directional valve can be activated in a similar fashion in that the actuation bolt 65.2 on the other side of the directional valve 39 is moved against the second stop 63.2. This mechanical activation of the directional valve 39 is possible without any further steps for any NC-controlled tool machine. This makes it possible to alternate between the various nozzle arrangements or switch positions of the directional valve 39 during the machining without any considerable interruption to the machining process, meaning that the optimal spindle rotational speed is available for each step of the machining process.

FIG. 17 shows a manual activation of the directional valve 39 by the machine operator. The operator is thus able to set the fluid flow, and thus which, how, and by what means rotors are supplied with fluid.

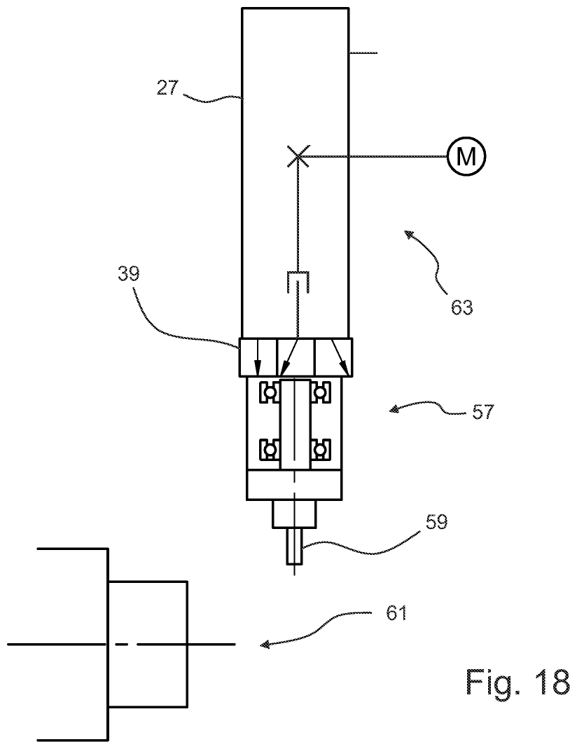

FIG. 18 shows the design of the fluid-supplied, driven tool holder 57 on a driven tool revolver 27. This makes it possible to use the drive 63 of the tool revolver to actuate the directional valves. The drive 63 comprises a motor (M) and a drive shaft. The drive 63 is normally used to drive what are known as driven tools. Because the spindle 3 of the tool holder described by the invention is fluid-driven, the drive shaft of the drive 63 is present for activation of the directional valve 39. The directional valve(s) are connected with the drive motor of the tool revolver drive via gears and shafts. Actuation of the drive motor specifically activates the directional valve(s) 39. This allows for the activation of the (directional) valve 39 via the controls of the tool machine. Not all details of the activation of the directional valve (39) by the drive 63 are pictured in FIG. 18.

FIG. 19 shows a highly schematised example variant of a rotor 9 cross section. The rotor 9 comprises a total of six scoops or bowls 61 that each comprise a concave or bowl-like shape on both sides. They are symmetrical with regard to a radius ray. This means that the rotational direction of the rotor 9 changes depending on which of the nozzle arrangements 15 or 17 is supplied with fluid. If the nozzle arrangement 15 is active, the rotor 9 rotates clockwise. If the nozzle arrangement 17 is active, the rotor 9 rotates counter-clockwise.

The scoops or bowls 61 of the rotor 9 can be a direct or integral component of the spindle 3. They can be welded to the spindle 3 or mounted onto the spindle 3 and are connected via a shaft-hub connection as per the current state of technology. In the simplified example variant shown in FIG. 19, the bowls 61 are positioned on a ring 63 that is in turn shrunk onto the spindle 3 or otherwise connected to the spindle 3 in such a manner that it cannot rotate.

FIG. 20 shows a cross section of a tool holder 57 described by the invention that is somewhat schematic and shows a few structural details.

Following are some general remarks on the example variants.

The configuration of the nozzle arrangements can define the jet speed and/or volume flow of the fluid emitted by a nozzle arrangement. For example, the nozzle arrangement 15 can be configured such that fluid exits the nozzle arrangement 15 at a higher speed than from the differently configured nozzle arrangement 17.

FIGS. 21 to 27 show and describe other example variants of tool holders described by the invention. In this example variant, the tool is integrated into the spindle. But it is also possible to provide a tool intake 5 on the spindle 3 and brace or receive the tool in this intake.

In the tool holder shown in FIGS. 21 to 27, the housing 1 comprises a shaft 65 that serves to brace the tool holder in a corresponding intake of a tool machine. The end of the shaft 65 comprises a (first) fluid connection 91.

Around the middle of the housing 1 is a collar 67. A positioning ring 69 described by the invention is positioned to the left of the collar 67 in FIG. 21.

Additional fluid connections (92) can be positioned on the positioning ring (69). Via one of the fluid connections (91, 92), the tool holder is supplied with the pressurised fluid required for driving the at least one turbine.

The second fluid connection 92 is a radial connection 92 on the positioning ring 69. The distribution space 86 (see FIGS. 22b, 22c, 22d) can be supplied with pressurised fluid via each of the fluid connections 91, 92. The invention describes use of only one of the fluid connections 91 (in the shaft 65 or 92) (in the positioning ring 69), and to seal the unused fluid connections with a plug 93, thereby deactivating them.

The positioning ring 69 is pressed against a sealing surface (not visible in FIG. 21) by a nut 71. The nut 71 is screwed onto a (fine) thread of the housing 1. Loosening or tightening a nut 71 onto the thread of the housing 1 can very finely configure a gap between the sealing surface of the housing and a countersurface of the positioning ring 69 during installation, and reduced to zero or even strained to achieve a good seal, and the positioning ring 69 can be twisted relative to the collar 67 or the housing 1. The twisting can be aided with an open-end spanner. The collar 67 is marked with “1”, “2”, “3”, “4”, and “5”. If the marking 73 “jets” of the positioning ring 69 is aligned with the marking “1” on the collar 67, a line supplies a nozzle arrangement with fluid. The fluid emitted from the nozzle arrangement drives a rotor 9 positioned on the spindle 3 (e.g., see FIG. 22b). If the positioning ring 69 in FIG. 21 is turned counter-clockwise to the point that the marking “2” of the collar 67 aligns with the marking 73 “jets” of the positioning ring 69, two lines are open, whereupon two nozzle arrangements become active. This applies accordingly to the other markings “3” to “5”.

A cover or cap 75 is positioned on the left end of the tool holder in FIG. 21. The cap 75 protects the interior of the housing, in particular the spindle and the rotor of the turbine.

FIGS. 22a, 22b, 22c, and 22d show a tool holder as per FIG. 21 in various cross sections.

FIG. 22a shows a top view of the tool holder, and the diverters (no reference number) for the “used” fluid are visible. It consists of a variety of small holes concentric to the spindle or tool. It also shows the cutting levels for FIG. 22b with the cutting process A-A, and for FIGS. 22c and 22d with the cutting process B-B.

The cutting process B-B is shown in two variants in which the position of the plug 93 is different. In FIG. 22c the plug is in the shaft 65 and thus seals the (first) fluid connection 91, while the second fluid connection (side connection) positioned radially on the positioning ring 69 is used for the fluid supply. In FIG. 22d, the plug is positioned in the side fluid connection 92 of the positioning ring 69 and the fluid is supplied via the fluid connection 91.

In these lengthwise cross-sections 22b, 22c, 22d, the spindle 3 and the bearing 7 as well as a very broad rotor 9 are visible. The fluid path through the housing 1 is further explained in FIGS. 22a to 22d, 23, and 25 to 27.

The first fluid connection 91 passes into a blind hole 77 in the shaft 65. There are multiple supply holes 79 on its end. Eight such supply holes 79 are shown in this example variant.

They begin on the end of the blind hole 77 in the immediate vicinity of the lengthwise axis of the shaft 65; they extend to the front end of the tool holder and face outward. In FIG. 23, the housing 1 is shown without additions. In this depiction, the radially outward ends of the supply holes 79 are easily recognisable. It can be seen from FIGS. 22a to 22d and 23 that the outer ends of the supply holes 79 end in a distribution space.

There is a second collar 95 at the distribution space 86. This second collar 95 contains multiple (axial) grooves 89 and a cone on one side. This “interrupted cone” is also the sealing surface 81. Multiple radial holes pass inward from this sealing surface between the grooves 89 with a tangential component. These holes are the lines 21, 22, 23, 24, 25, which open or pass into the nozzle arrangement 15, 16, 17, 18, 19.

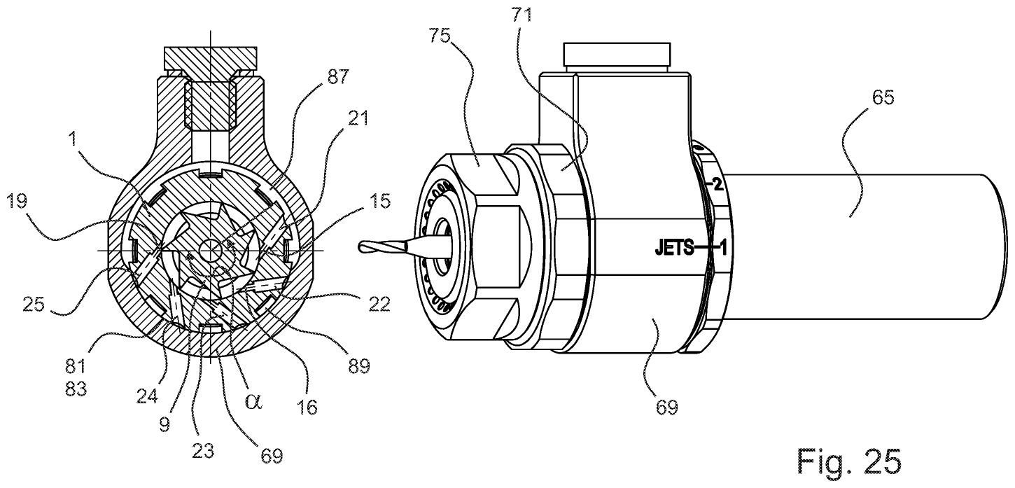

The course of the lines 21, 22, 23, 24, 25 can be determined from FIGS. 23 and 25. Overall, there are five lines in this example variant that are distributed across about half the circumference of the housing 1 (based on a central angle alpha of just over 180°).

The alignment of the lines 21 to 25 has a tangential component. A nozzle arrangement 15, 16, 17, 18, 19 is connected to each of the lines. The fluid can exit the nozzle arrangements 15 to 19 at a high speed, and exert a tangential influence on the rotor 9 and cause it to rotate.

The repositioning of the directional valve described by the invention occurs as follows: By twisting the positioning ring 69 relative to the housing 1 or the sealing surface 81, the number of opened or closed lines 21, 22, 23, 24, 25 is set. The volume flow of the fluid that passes through the lines 21, 22, 23, 24, 25 and makes contact with the rotor 9 via the nozzle arrangements 15, 16, 17, 18, 19 changes accordingly. There the fluid exerts an influence with a tangential directional component on the rotor and causes it to rotate. The torque of the rotor 9 depends on the volume flow of the fluid making contact with it, among other things. If the number of opened lines 21 to 25 is changed by the twisting of the positioning ring 69, the torque that the rotor 9 exerts on the spindle 3 and thus on the tool intake 5 also changes. In other words: By activating more or fewer lines and nozzles, the tool holder can be easily adjusted to the machining of various materials and tools with different diameters.

The torque and the rotational speed of the spindle 3 also depend on the speed at which the fluid makes contact with the rotor 9.

The positioning ring 69 is shown in more detail in FIG. 24. The positioning ring 69 comprises a countersurface 83 in its interior. This countersurface is complementary to the sealing surface 81 in the housing 1. This countersurface 83 does not extend across the entire circumference of the positioning ring 69, but rather about half of the circumference. There is a recess 85 on the remainder of the circumference. In its installed state, there is a ring-shaped fluid space 87 between the recess 85 and the housing 1 of the tool holder, which includes a central angle beta of approx. 180° in this example variant.

If one considers the FIGS. 25, 26, and 27, one can see that the countersurface 83 of the positioning ring 69 interacts with the sealing surface 81 of the housing 1. Depending on which of the positions “1” to “5” the positioning ring 69 adopts, the countersurface 83 closes one or more of the lines 21 to 25.

The recess 85 is shown in the upper part of FIG. 22, so that the aforementioned ring-shaped fluid space 87 is formed between the sealing surface 81 of the housing 1 and the positioning ring 69. The fluid space 87 extends only across a circumferential angle of 180°. It serves to create a hydraulic connection between one or more supply holes 79 and one or more lines 21 to 25. In the rotational position of the positioning ring 69 shown in FIG. 22b, the line 21 is hydraulically connected to a supply hole 79 via the fluid space 87.

When this hydraulic connection is present, the corresponding line 21 supplies a nozzle arrangement 15 with fluid that flows into the line 21 via the blind hole 77, the supply hole 79, the distribution space 86 and the fluid space 87.

FIGS. 25, 26, and 27 show three (of five) different switch positions of the directional valve described by the invention. In FIG. 25, the positioning ring 69 is positioned relative to the housing 1 such that the fluid space 87 is supplied with pressurised fluid via multiple supply holes 79 (not pictured). Via the line 21, the fluid flowing into the fluid space 87 moves toward the nozzle 15, and is accelerated there. The pressure energy of the fluid is converted into kinetic energy. This kinetic energy makes contact with the rotor 9 and makes it rotate clockwise. The lines 22 to 25 are closed off from the countersurface 83 of the positioning ring 69 in the rotational position of the positioning ring 69 shown in FIG. 25.

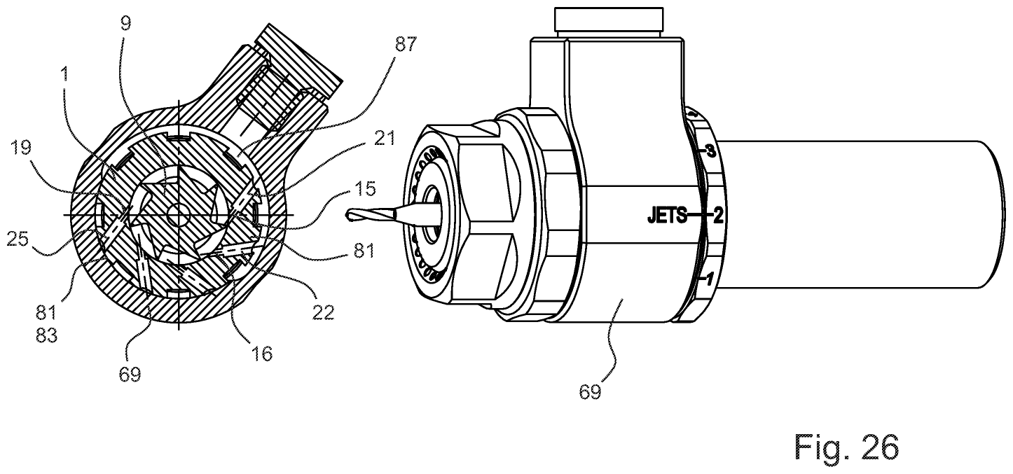

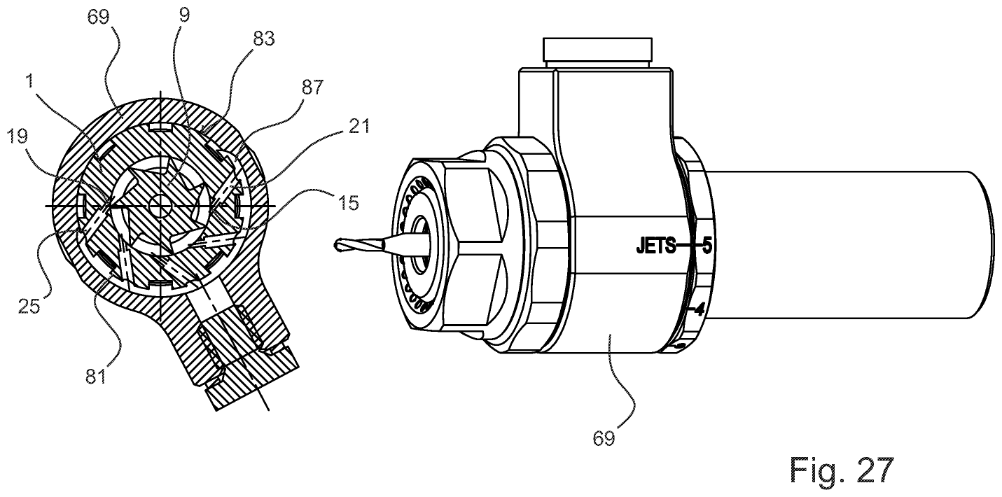

In FIG. 26, the positioning ring 69 is turned somewhat further relative to the housing 1, so that the fluid space 87 now supplies lines 21 and 22 with pressurised fluid. As a result, the rotor 9 is supplied with twice the fluid quantity, so that the torque exerted by the rotor 9 on the spindle 3 is doubled under the same conditions. In the switch position shown in FIG. 27, all five lines 21 to 25 are supplied with pressurised fluid via the fluid space. As a result, the rotor 9 is supplied with the maximum fluid amount that is about 5 times as great as that in FIG. 25.

### REFERENCE LIST

1 Housing
3 Spindle
5 Tool intake
7 Roller bearing
9, 11, 13 Rotor
15, 16, 17, 18, 19 Nozzle arrangement
21, 22, 23, 24, 25 Line
27 Revolver
29 Pump
31 Conveying side
33, 35, 37, 39 Directional valve
41 Throttle
42 Flywheel mass
43, 45 Diverter
47, 48, 49 Seal
51 Rotational speed sensor
53 Evaluation unit (with optional sender)
55 Recipient
57 Tool holder
58 Signal lines
59 Tool
61 Work piece
63 Revolver drive
65 Shaft
67 Collar
69 Positioning ring
71 Nut
73 Marking
75 Cover/cap
77 Blind hole
79 Supply hole
81 Sealing surface
83 Countersurface
85 Recess
86 Distribution space
87 Fluid space
alpha, β, γ Central angle
89 Grooves
91 Rear fluid connection
92 Side fluid connection
93 Plug
95 Second collar

1. A driven tool holder comprising,
a spindle with a free jet turbine, whereby the free jet turbine includes a line, a nozzle arrangement, and a rotor positioned on the spindle, wherein
the free jet turbine includes two or more nozzle arrangements, that each nozzle arrangement is assigned a line the fluid supply, and that the lines are opened and/or closed with the one or more directional valve(s).

2. The driven tool holder comprising:
a spindle with a free jet turbine, whereby the free jet turbine includes a line, a nozzle arrangement, and a rotor positioned on the spindle; and
a directional valve, that the directional valve includes two outputs that open into the line, that there is a throttle in at least one of the outputs downstream from the directional valve, and that the outputs open into the line.

3. The driven tool according to claim 1, further comprising: the nozzle arrangement, each with one or more nozzles, on the ends of the lines.

4. The driven tool holder according to claim 1, wherein the fluid emitted by the at least two lines or nozzle arrangements drives the spindle in the same direction of rotation or opposing directions of rotation.

5. The driven tool holder according to claim 1, wherein the turbine includes two or more rotors, and that each rotor is assigned at least one line or at least one nozzle arrangement.

6. The driven tool holder as per claim 5, wherein the rotors have various diameters.

7. The driven tool holder according to claim 1, wherein the directional valves that open or close the lines are positioned on a tool machine.

8. The driven tool holder according to claim 1, wherein the at least one directional valve that opens or closes the lines is positioned in the tool holder.

9. The driven tool holder according to claim 8, further comprising: two lines, and that a controllable throttle is contained in one of the lines.

10. The driven tool holder according to claim 1, wherein the tool intake is positioned on a first end of the spindle, and that one of the rotors is positioned on the first end of the spindle and/or on a second end opposite the first end of the spindle.

11. The driven tool holder according to claim 1, wherein the spindle is integrated in bearings in a housing of the tool holder in such a manner that the spindle can rotate.

12. The driven tool holder as per claim 11, wherein there is at least one rotor between two bearings.

13. The driven tool holder according to claim 8, wherein the directional valve includes a circular positioning ring and an annular or conical sealing surface that interacts with the positioning ring, that the lines are distributed via a circumferential angle of the sealing surface, and that the positioning ring releases or closes one or more of the lines depending on its rotational position relative to the housing.

14. The driven tool holder according to claim 13, wherein the positioning ring includes a countersurface that complements the sealing surface, that the countersurface is an annulus or a cone with a central angle of less than 360°, and that the positioning ring includes a recess in the circumference before or following the countersurface.

15. The driven tool holder according to claim 1, wherein the housing borders a distribution space.

16. The driven tool holder according to claim 1, further comprising: one or more fluid connections.

17. The driven tool holder as per claim 16, wherein there is at least one fluid connection on the positioning ring and/or that there is at least one fluid connection on the housing.

18. The driven tool holder according to claim 1, further comprising: at least one seal.

19. The driven tool holder according to claim 1, further comprising: at least one diverter for the fluid.

20. The driven tool holder according to claim 1, further comprising: a sensor arrangement and/or evaluation unit for determining the rotational speed of the spindle and/or other operating states of the tool holder.

21. The driven tool holder as per claim 16, wherein the sensor arrangement and/or the evaluation unit is connected to an external control unit either wirelessly or via a grid connection.

22. The driven tool holder according to claim 21, wherein the external control unit actuates the directional valve(s) and/or a throttle.

23. The driven tool holder according to claim 1, wherein the directional valve(s) are translationally or rotationally repositioned.

24. The driven tool holder according to claim 16, wherein the sensor data recorded by the sensor arrangement are used to control the directional valves.

25. The driven tool holder according to claim 20, wherein the sensor data are processed in the evaluation unit, from which the directional valves are controlled.

26. The driven tool according to claim 1, wherein the spindle bears a flywheel mass.

27. The driven tool holder according to claim 1, wherein at least one rotor is designed for left-rotating and right-rotating operation.

28. The driven tool holder according to claim 1, wherein the spindle comprises a tool intake or that the tool is integrated into the spindle.
